(19) United States
(12) Patent Application Publication
(10) Pub. No.: US 2003/0018978 A1
(43) Pub. Date: Jan. 23, 2003

(54) Transfer file format and system and method for distributing media content

(76) Inventors: Sanjay S. Singal, Mountain View, CA (US); Jayakumar Muthukumaraswamy, Dublin, CA (US)

Correspondence Address: R. Michael Ananian, Flehr Hohbach Test Albritton and Herbert LLP, Suite 3400, Four Embarcadero Center, San Francisco, CA, 94111, US

(21) Appl. No.: 10/090,697

(22) Filed: Mar. 4, 2002

Related U.S. Application Data
(60) Provisional application No. 60/272,944, filed on Mar. 2, 2001.

(51) Int. Cl. H04N 7/173

(52) U.S. Cl. 725/115

(57) ABSTRACT

Transfer file format, system, signal, and method for performing distribution of media content across computer networks. Transfer file and signal includes signature identifying format of file, header containing information about various parts of transfer file, asset metadata describing technical details about media content, media content that is capable of being displayed to user by client computer system using media player program, and user metadata that is capable of being displayed to user. Server is capable of connection to asset metadata database, file system, and user metadata database, and includes extractor module for retrieving asset metadata from media asset database, media content from file system, and user metadata from user metadata database, and assembling them into transfer file. Extractor module places header and signature in transfer file, and transfer file is sent across computer network to clients that parse and install parts of transfer file into local systems.

### RELATED APPLICATIONS

This application claims priority to co-pending U.S. Provisional Patent Application Serial No. 60/272,944, filed Mar. 2, 2001, with the United States Patent and Trademark Office, which is incorporated herein by reference.

### FIELD OF INVENTION

The present invention relates broadly to system, method, signal, and computer pro gram for delivery of streaming media assets over a computer network having a client server computer architecture. Specifically, the present invention relates to a file format and system that accommodates point-to-point delivery as well as point-to-multipoint delivery of streaming media assets.

### BACKGROUND

Multimedia assets such as video, audio and the other forms of content can be encoded and streamed in many different ways. Generally, streaming media assets are delivered across communication networks such as the Internet according to point-to-point or point-to-multipoint schemes. In a point-to-point distribution model, a server that administers the media assets receives a request from a client for delivery of the media asset, negotiates delivery details such as delivery time, bit rate, and other parameters that specify how delivery is to be performed for a single client. In point-to-multipoint distribution, the server streams the media asset to multiple clients that utilize similar delivery parameters so that all clients receive the media asset in a substantially simultaneous manner. However, the negotiation between the server and each of the multiple clients is still required in the point-to-multipoint distribution model, as each client must be aware of what resources such as bandwidth, processing speed and memory size must be reserved or allocated for the incoming media asset: For instances where the number of clients desiring simultaneous delivery is high, this negotiation overhead is quite high in terms of time. Additionally, there exists no single format for a file containing a media asset. This means that, depending on client demand, multiple servers are required to handle both point-to-point and point-to-multipoint distribution methods. Maintaining multiple, dedicated servers incur substantially higher operating costs and reduced profits for commercial servers.

Thus, there is a need for a file format that can reduce the amount of negotiation required between clients and server as well as more efficient system for performing delivery of media assets.

### SUMMARY

The present invention overcomes the problems discussed above by providing a file format and system for efficient streaming of media assets from a server to one or more clients. In one aspect, the present invention provides a transfer file format that is suitable for point-to-point or point-to-multipoint distribution of transfer files between a server and one or more clients across a computer network, wherein the transfer file includes a signature indicating the format of the file, a header containing information related to various portions of the transfer file, asset metadata describing media content, media content that is capable of being displayed to a user, and user metadata that describes the media content and is capable of being displayed to the user. The media content may include a video object accompanied by one or more static images such as GIF images, html pages, and the like. By organizing the file format to include the asset metadata that is used by a media player program on the client side, the time consuming negotiation between client and server is eliminated and a more efficient transmission of media content is implemented.

In another aspect, the present invention provides a server computer system and method that is capable of connection to an asset metadata database containing the asset metadata, a file system containing the media content, and a user metadata database containing the user metadata, wherein the server includes an extractor module that constructs the transfer file by receiving a request for delivery in the form of an asset identifier, writing the asset metadata associated with the asset identifier from the asset metadata database into the transfer file, writing the media content associated with the asset identifier into the transfer file, and writing the user metadata associated with the asset identifier into the transfer file. Once these portions of the file are constructed, the extractor module inserts a header that includes information about the portions into the transfer file and the transfer file is sent across the computer network to one or more clients.

In another aspect, the present invention provides a client computer system and method for receiving transfer files as described above, wherein the client is capable of connection to a local asset metadata database, a local file system, and a local user metadata database. The client includes aparser module for processing the transfer file and allocating resources as required for the various parts of the transfer file. An installer module is included for installing the asset metadata in the local asset metadata database, the media content in the local file system, and the user metadata in the local user metadata database.

In another aspect, the invention provides an electronic signal, generally a digital electronic signal, encoding the transfer file or parts thereof, either alone or in addition to media content.

Other aspects of the invention will become apparent from reading the following detailed description and related drawings.

### BRIEF DESCRIPTION OF THE DRAWINGS

FIG. 1 illustrates in block diagram form the client server architecture utilized in embodiments of the present invention.

FIG. 2 illustrates in block diagram form an embodiment of the file format of the transfer file of the present invention.

FIG. 3 illustrates in flow chart form an embodiment of the logical sequence of steps executed by the extractor module running on the server to assemble a media asset into a transfer file.

FIG. 4 illustrates in flow chart form an embodiment the logical sequence of steps executed by the parser module running on the client to receive the transfer file and allocate resources for the various parts of the transfer file.

FIG. 5 illustrates in flow chart form an embodiment of the logical sequence of steps executed by the installer module running on the client to write the various parts of the transfer file to facilities used by the client.

FIG. 6 illustrates in block diagram form an embodiment of the components included in a computer used by either the clients or the server.

### DETAILED DESCRIPTION

The present invention provides a file format and data structure that can be used for either point-to-point or point-to-multipoint distribution of media assets. Transfer of metadata associated with the media assets is supported. User defined metadata associated with video objects can be transferred using this file format, as well as one or more content and auxiliary files. The file format of the present invention supports transfer of necessary information for network-backed-assets. Because the file format is text-based, the file format allows pluggability of metadata in different formats such as plain text, XML, and the like.

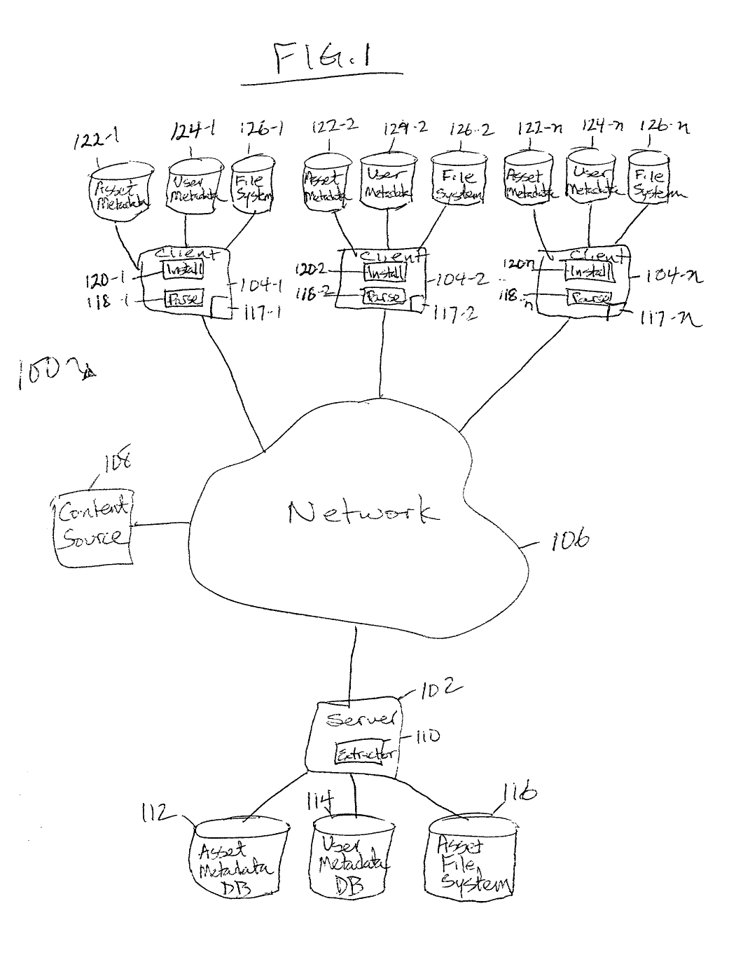

Directing attention to FIG. 1, the present invention utilizes a client-server computer architecture 100 communicating over a network, such as a large public computer network such as the Internet. Server 102 is responsible for distributing streaming media assets such as video, audio, static images, graphics, or a combination thereof to clients 104-1, 104-2, . . . , 104-n, where n is the number of clients requiring streaming media assets, via public computer network 106. Media assets are streamed by transmitting a sequence of packets from the server 102 to the client 104. Once the client has the media asset it can later serve the media asset to other media players. These media players may then decrypt, decode, or otherwise process the media asset (or allow the player to process the media asset after receipt) to play or render the media asset on a suitable device using a media player program that decompresses, decodes, and performs any necessary processing on the sequence of packets received from the server 102 to present aural or visual presentation contained in the packets to a user. Examples of streaming media assets include movies, newscasts, music, graphics, animation, slide presentations, and the like, all of which are capable of being presented in a serial fashion to a human user. Server 102 may be a source of the streaming media assets. Optionally, one or more third party content providers such as content provider 108 may be in communication with server 102, and provide the streaming media assets to the server 102 over network 106. Media assets are typically stored in files in the memory of the server 102 and distributed to clients on demand or according to a schedule.

Server 102 includes an extractor module 110 which includes instructions executed to assemble a media asset into a file format that is easily transferred over computer network 106 to clients 104 in a multicast transmission model. In order to assemble the media asset into a transfer file, the extractor module 110 reads data from asset metadata database 112, user metadata database 114, and asset file system 116. Client 104 includes a media player program 117 such as Media Base, available from Kasenna, Inc. of Mountain View, Calif., which is capable of playing out a media asset in a manner which is observable by a user. For example, the media player program 117 can display media assets having an MPEG format on a computer monitor. Client 104 incorporates a parser module 118 which reads the transfer file containing the media asset and associated data and installer module 120 installs various portions of the transfer file into local asset metadata database 122, user metadata database 123, and files system 126.

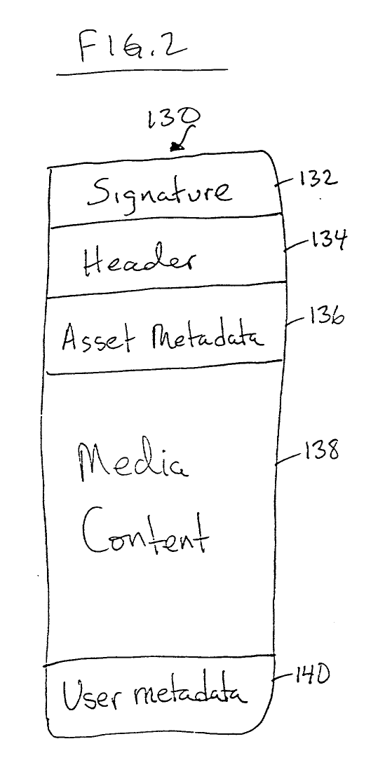

FIG. 2 illustrates the structure of an embodiment of the file format of transfer file 130 of the present invention. Transfer file 130 includes a signature 132, which identifies to a client that the transfer file contains a media asset organized according to file format of transfer file 130. Header 134 follows signature 132, and defines such information as the format(s) of the media content 138, such as MPEG, PGM, RMTP, and the like, the size, duration and bit rate of the media content 138, the size of the asset metadata 136 and user metadata 140, and other information. Asset metadata 136 follows header 134, and may include such information as the name or ID of the source of the media content 138, the creation time and/or modification time of the media content, which is useful if multiple versions of the media asset exist, keywords such as metatags, number of plays for the media content 138, fast forward or reverse file size, a unique media asset identifier, and other information. Asset metadata 136 is stored on the server side in asset metadata database 112. Once the transfer file 130 is received by the client 104, the asset metadata 136 is stored in asset metadata database 122. Following the asset metadata 136 is the media content 138. The media content 138 includes the media asset to be played by the user, as well as any additional or enhanced content, such as alternative views from multiple camera angles used for sporting events and the like. Media content 138 can thus include multiple files, such that for example, an MPEG file is accompanied by JPEG files, GIF images, html pages, and the like. Media content 138 is stored on the server side in asset file system 116. Once the transfer file 130 is received by the client 104, the media content 138 is stored in file system 126. Following the media content 138 is user metadata 140, which may contain information related to media content 138 that can be displayed to a user. For example, if the media asset is a movie, user metadata 140 can optionally include one or more of a director name, actor names, ratings information, duration of the movie, plot synopsis, and the like. User metadata 140 is stored on the server side in user metadata database 114. Once the transfer file 130 is received by the client 104, the user metadata is stored in user metadata database 124.

An example of header 134 follows. The header 134 consists of a list of name-value pairs separated by newline characters. The following name-value pairs for the header are exemplary and others may be defined. Note that the value part follows the colon “:” separator. The type of the value field is specified below. A string representation of the value is used in an embodiment. In cases where multiple forward slash (“/”)-separated fields are specified, the various fields represent the various possible values for that item. Of course, other field differentiation than “:” or “/” may alternatively be used. The values of these fields are defined in a file, such as in the mbase/lib/mbtransferff/nvpair_defs.h header file in one embodiment. An exemplary embodiment of this file is shown in Table I. An example of the asset metadata 136 is shown in Table II.

TABLE I
Exemplary embodiment of a header file.

* MB_VERSION:int
* MB_ASSET_TYPE:(MB_ASSET_TYPE_SIMPLE/
* MB_ASSET_TYPE_PARALLEL/
* MB_ASSET_TYPE_VIEW/
* MB_ASSET_TYPE_SEQUENTIAL/
* MB_ASSET_TYPE_MULTIFORMAT)
* MB_FORMAT: (MB_FORMAT_MPEG1/
* MB_FORMAT: (MPEG1_AUDIO/
* MB_FORMAT_MPEG2/
* MB_FORMAT_H263/
* MB_FORMAT_QT/
* MB_FORMAT_QT_RTP/
* MB_FORMAT_GSM/
* MB_FORMAT_RMEDIA_V1/
* MB_FORMAT_CONTAINER)
* MB_BITRATE: ull
* MB_DURATION: ull
* MB_METADATA_FORMAT: (MB_METADATA_FORMAT_NV_PAIRS/
* MB_METADATA_FORMAT_XML)
* MB_METADATA_SIZE: ull
* MB_MAIN_FILESIZE: ull
* MB_FF2N_FILESIZE: ull
* MB_FFREW_FILESIZE: ull
* MB_EFREW_INDEX_FILESIZE: ull
* MB_INDEX_FILESIZE: ull
* MB_N2FF_FILESIZE: ull
* MB_GENERIC_NUM_AUX: ull
* MB_GENERIC_AUX%d_SIZE: ull
* MB_USER_METADATA_SIZE: ull

TABLE II
Exemplary Embodiment of an Asset Metadata

* Common Asset fields
*
*
* MB_COMMENT: string
* MB_SOURCE_HOSTNAME: string
* MB_SOURCE_HANDLENAME: string
* MB_SOURCE_ASSETID: ull
* MB_SOURCE_LAST_MOD_TIME: ull
*
* Simple
* —
*
* MB_SOURCE_ASSETGROUP: string
* MB_AUXILIARIES: (MB_AUXILIARIES_NONE/
* MB_AUXILIARIES_POSITIONING_ONLY/
* MB_AUXILIARIES_FF_REWIND_SUPPORT)
* MB_BACKINGSTORE: (MB_BACKINGSTORE_NONE/
* MB_BACKINGSTORE_CD/
* MB_BACKINGSTORE_NETWORK)
* MB_NUMBER_OF_PLAYS: uint32
* MB_PLACEMENT: (MB_PLACEMENT_AUTO/
* MB_PLACEMENT_SHARED/
* MB_PLACEMENT_FORCED)
* MB_REALTIME: (MB_TRUE/
* MB_FALSE)
* MB_CONTDESC_TYPE: (MB_CONTDESC_TYPE_GENERIC/
* MB_CONTDESC_TYPE_MPEG1/
* MB_CONTDESC_TYPE_MPEG2/
* MB_CONTDESC_TYPE_H263)
* MB_DATATYPE: (MB_DATATYPE_NULL/
* MB_DATATYPE_ZERO/
* MB_DATATYPE_INDEX/
* MB_DATATYPE_PURE_DATA/
* MB_DATATYPE_SYNC_MARK_DATA/
* MB_DATATYPE_USER_DATA)
* MB_FFREW_FILESIZE: ull
* MB_FFREW_INDEX_FILESIZE: ull
* MB_INDEX_FILESIZE: ull
* MB_N2FF_FILESIZE: ull
* MB_GENERIC_NUM_AUX: ull
* MB_GENERIC_AUX%d_SIZE: ull
* MB_PLAYMODE: uint32
* MB_IMAGEWIDTH: uint32
* MB_IMAGEHEIGHT: uint32
* MB_MINLOADSIZE: ull
* MB_MEDIAINFO: octetlist
* MB_FFRATEMULTIPLE: float
* MB_ASPECTRATIO: float
* MB_PACKHEADER: octetlist
* MB_SYSTEMHEADER: octetlist
* MB_VIDEOHEADER: octetlist
* MB_AUDIOHEADER: uint32
* MB_VSHEADER: octetlist
* MB_TRANSPORTHEADER: octetlist
* MB_PESHEADER: octetlist
* MB_PDS: uint32
* MB_PSITABLES: octetlist
*
* View
* —
* MB_UNDERLYING_ASSET_GUID: string (source_hostname##source_asset_id)
* MB_START_OFFSET_TIME: ull
* MB_END_OFFSET_TIME: ull
*
*
* Sequence
* —
* MB_COMPONENLIST_SIZE: uint32
* MB_COMPONENT_ASSET%d_GUID: string (source_hostname##source_asset_id)
* MB_COMPONENT_ASSET%d_GUID: string (source_hostname##source_asset_id)
*
*
* Multiformat
* —
* MB_ASSETENTRYLIST_SIZE: uint32
* MB_ASSETENTRY%d: string (format##source_hostname##source_asset_id)
* MB_ASSETENTRY%d: string (format##source_hostname##source_asset_id)
*

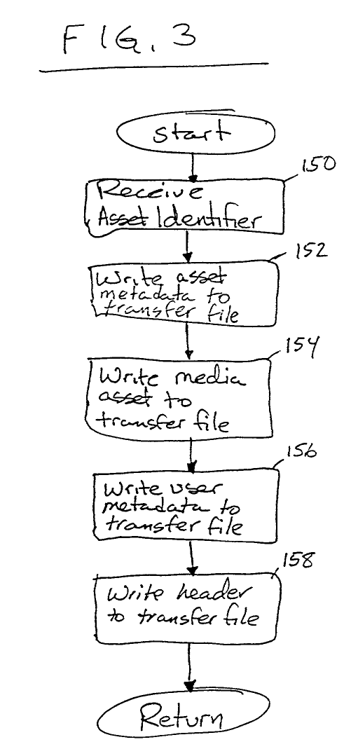

FIG. 3 illustrates in flowchart form an embodiment of the logical sequence of steps executed by the extractor module 110. Beginning at step 150, the extractor module 110 is passed a media asset identifier, a numeric value that uniquely identifies a media asset stored in asset file system 116. At step 152, the extractor module 110 reads the asset metadata associated with the received media asset identifier from asset metadata database 112 and places it in transfer file 130. At step 154, the extractor module 110 reads the media asset associated with the media asset identifier from the asset file system 116 and places it in the transfer file 130. At step 156, the extractor module 110 reads the user metadata associated with the media asset identifier from the user metadata database 114 and places it in transfer file 130. At step 158, the extractor module places a signature at the top of transfer file 130.

When the transfer file 130 is created as illustrated in FIG. 3, the server 102 can send the transfer file 130 across the network 106 to any number of clients 104. Clients 104 incorporate a parser module 118 which contains instructions for reading the transfer file 130 and processing its various elements 132-140.

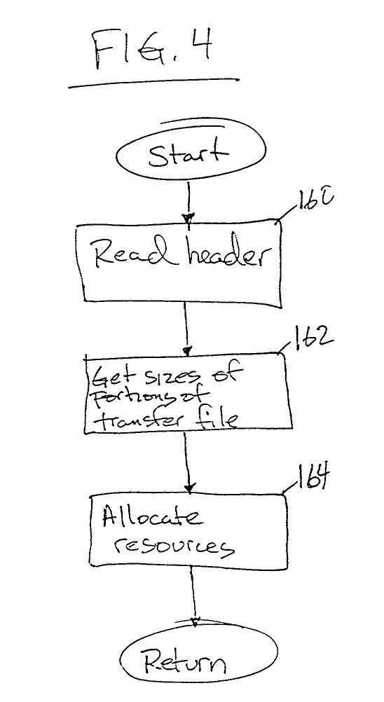

FIG. 4 illustrates the logical sequence of steps executed by the parser module 118. Beginning at step 160, the parser module 118 reads the signature 132 at the beginning of transfer file 130. By reading the signature 132, the parser 118 recognizes the transfer file 130's format and is able to accurately identify the remaining portions of the transfer file 130. At step 162, the parser reads the header 134 and obtains the sizes of the asset metadata 136, media content 138, and user metadata 140. With the size information obtained in step 162, the parser module 118 at step 164 allocates resources on the client 104 as well as the asset metadata database 122, user metadata database, and file system 126. At step 166, the parser module 118 invokes the installer module 120.

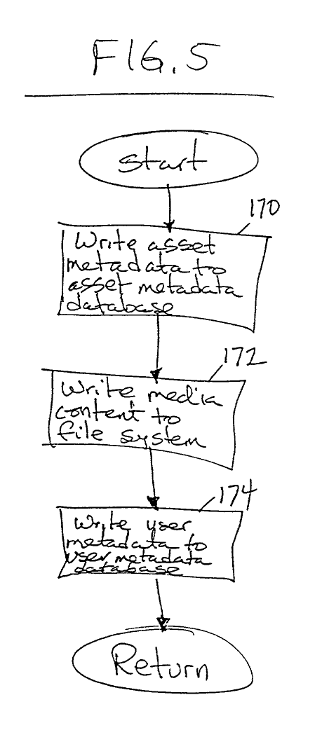

FIG. 5 illustrates the logical sequence of steps executed by the installer module 120. Beginning at step 170, the installer module 120 writes the asset metadata 136 into an area of the asset metadata database 122 that was allocated by the parser module 118 in step 164. At step 172, the installer module 120 writes the media content 138 to an area of the file system 126 that was allocated by the parser module 118 at step 164. At step 174, the installer module 120 writes the user metadata 140 to an area of the user metadata database 124 that was allocated by the parser module 118 in step 164. Once the transfer file 130 is read and the various portions 136, 138, and 140 are written to written to the asset metadata database 122, file system 126, and user metadata database 124, respectively, the asset is ready for playout by the media player program 117 when the user is ready to observe the media content 138.

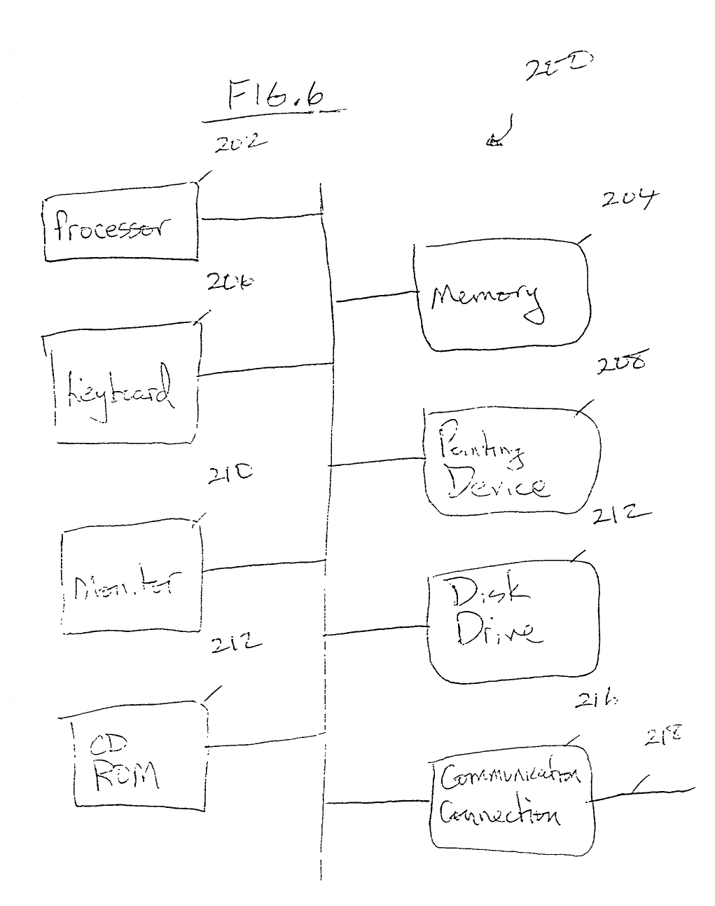

FIG. 6 illustrates in block diagram form the major components included in a computer embodying either server 102 or client 104. Computer 200 incorporates a processor 202 such as a central processing unit (CPU) and supporting integrated circuitry. In the preferred embodiment, work stations such as Sun Ultra computers available from Sun Microsystems can be used as server 102. Personal computers such as available from Dell Corporation may be used for client computers 104. However, in general any type of computer may be used for a server and any type of computer or even various information appliances may be used for the client. Memory 204 may include one or more of RAM and NVRAM such as flash memory, to facilitate storage of software modules executed by processor 202, and file systems administering media assets. As referred to herein, a file system refers to any administrative entity implemented by computer 200 to organize and administer media assets. File systems can include conventional file systems, direct attached storage, network attached storage, storage area networks, both block based and file based, raw storage, and the like. Also included in computer 200 are keyboard 206 or other input device, pointing device 208, and monitor 210, which allow a user to interact with computer 200 during execution of software programs. Mass storage devices such as disk drive 212 and CD ROM 214 may also be in computer 200 to provide storage for computer programs, associated files, and media assets. In one embodiment, database products available from Oracle Corp. may be utilized in connection with file systems as a database and database server.

Computer 200 communicates with other computers via communication connection 216 and communication line 218 to allow the computer 200 to be operated remotely, or utilize files stored at different locations, such as content provider 108. Communication connection 206 can be a modem, network interface card, or other device that enables a computer to communicate with other computers. Communication line 218 can be a telephone line or cable, or any medium or channel capable of transferring data between computers. In alternative embodiments, communication connection 221 can be a wireless communication medium, thus eliminating the need for communication line 218. The components described above may be operatively connected by a communications bus 170.

Having disclosed exemplary embodiments and the best mode, modifications and variations may be made to the disclosed embodiments while remaining within the scope of the present invention. All patents, patent applications, or other references made herein are hereby incorporated by reference.

What is claimed is:

1. A file format for distributing media content from a server computer to a client computer in the form of a transfer file, the file format comprising:
a header section, said header section including media type information, bit rate information describing a bit rate at which a media asset plays out on the client computer, information indicating the time duration of the media asset, and size information for various portions of the transfer file; and
an asset metadata section, said asset metadata section including a source host name, a source asset identifier, and a value indicating a number of plays of the media asset can be played out on the client computer.

2. The file format of claim 1, further comprising media content, said media content including the media asset described by the header section and the asset metadata section.

3. The file format of claim 1, further comprising a signature that identifies the file format to a client computer.

4. The file format of claim 2, further comprising a signature that identifies the file format to a client computer.

5. The file format of claim 1, further comprising a user metadata section, said user metadata including information that can be presented to a user.

6. The file format of claim 2, further comprising a user metadata section, said user metadata including information that can be presented to a user.

7. The file format of claim 2, wherein the media content comprises a movie and the user metadata includes a director name, plot synopsis, and actor names.

8. The file format of claim 6, wherein the media content comprises a movie and the user metadata includes a director name, plot synopsis and actor names.

9. The file format of claim 2, wherein the media content is presented in an MPEG format and the header section specifies a fast forward/rewind file size.

10. The file format of claim 2, wherein the media content is presented in an MPEG format and the header section specifies an index file size.

11. The file format of claim 1, further comprising:
media content, said media content including the media asset described by the header section and the asset metadata section;
a signature that identifies the file format to a client computer;
a user metadata section, said user metadata including information that can be presented to a user;
the media content comprises a movie and the user metadata includes a director name, plot synopsis, and actor names; and
the media content is presented in an MPEG format and the header section specifies a fast forward/rewind file size.

12. A server computer system for distributing media content to clients over a computer network, the server capable of connection to an asset metadata database containing metadata describing the media content, and a file system containing the media content, the server comprising:
an extractor module that assembles a transfer file containing the media content and metadata; and
a network connection capable of transmitting the transfer file to at least one client over the computer network.

13. The server computer of claim 7, wherein the media content is transmitted to the clients in a point-to-multipoint manner.

14. The server computer of claim 13, wherein said media content comprises video content.

15. The server computer system of claim 12, wherein the asset metadata is used by a media player program on the client to process the media content and display the media content to a user.

16. The server computer system of claim 12, wherein the server is capable of connecting to a user metadata database containing user metadata that is associated with the media content and is capable of being displayed to a user, and the extractor module copies the user metadata into the transfer file.

17. The server computer system of claim 12, wherein the media content includes a video object.

18. The computer system of claim 17, wherein the media content includes at least one GIF image accompanying the video object.

19. The computer system of claim 17, wherein the media content includes at least one html page accompanying the video object.

20. A server computer system for distributing media content to client computer systems over a computer network in a point-to-multipoint manner, wherein the media content includes a video object accompanied by at least one static image, wherein the server is capable of connection to an asset metadata database containing asset metadata that is used by a media player on the client wherein the asset metadata describes the media content and the server computer system is capable of connection to a file system containing the media content, the server comprising:
an extractor module that assembles a transfer file containing the media content and metadata by writing asset metadata from the asset metadata database to the transfer file and by writing the media content from the file system to the transfer file; and
a network connection capable of transmitting the transfer file to at least one client over the computer network.

21. A client computer system for displaying media content to a user, the client computer comprising:
a media player program for decoding and displaying media content received over a computer network to a user;
a parser module for processing a transfer file received from a server computer, the transfer file including media content and related metadata, the parser module allocating resources on the client computer system in response to processing the received transfer file;
an installer module for storing various portions of the received transfer file on the client computer system; and
a network connection for receiving the transfer file over a computer network.

22. The client computer system of claim 21, further comprising an asset metadata database, wherein the installer module stores the related metadata in the asset metadata database.

23. The client computer system of claim 21, further comprising a file system, wherein the installer module stores the media content in the file system.

24. A method of performing content distribution between a server computer and a client computer communicating with each other across a computer network, wherein the server computer is capable of connection to a file system containing media content and an asset metadata database containing asset metadata describing the media content, the method comprising the steps of:
assembling a transfer file containing the media content and metadata by writing asset metadata from a asset metadata database to the transfer file and by writing the media content from the file system to the transfer file; and
transmitting the transfer file to at least one client over the computer network.

25. A method of performing content distribution between a server computer and a client computer communicating with each other across a computer network, wherein the client computer is capable of connection to a file system for storing media content and an asset metadata database for storing asset metadata describing the media content, the method comprising the steps of:
receiving a transfer file including a header that describes portions of the transfer file, media content and metadata describing the media content;
reading the header to determining sizes of portions of the transfer file;
allocating resources for the portions of the transfer file;
installing the metadata in the metadata database; and
installing the media content in the file system.

26. An electronic signal including digitally encoded data for distributing media content from a server computer to a client computer in the form of a digital signal encoding a transfer file, the digital signal comprising:
a first digital signal portion encoding a header section, said header section including media type information, bit rate information describing a bit rate at which a media asset plays out on the client computer, information indicating the time duration of the media asset, and size information for various portions of the transfer file; and
a second digital signal portion encoding an asset metadata section, said asset metadata section including a source host name, a source asset identifier, and a value indicating a number of plays of the media asset can be played out on the client computer.

27. The signal of claim 26, further comprising a third digital signal portion encoding media content, said media content including the media asset described by the header section and the asset metadata section.
